(19) United States
(12) Patent Application Publication
(10) Pub. No.: US 2004/0111321 A1
(43) Pub. Date: Jun. 10, 2004

(54) Graphical display system for use with a computerized point-of-sale system

(76) Inventor: James B. Kargman, Chicago, IL (US)

Correspondence Address: GREENBERG TRAURIG, P.C., Suite 2500, 77 West Wacker Drive, Chicago, IL, 60515, US

(21) Appl. No.: 10/637,603

(22) Filed: Aug. 8, 2003

Related U.S. Application Data
(60) Provisional application No. 60/402,433, filed on Aug. 9, 2002.

(51) Int. Cl. G06F 17/60

(52) U.S. Cl. 705/16

(57) ABSTRACT

A graphical display system for use in a pizza restaurant, including an image generator and a display monitor positioned at a customer order station for displaying to the customer a photo-realistic image of a cooked pizza ordered by the customer prior to finalizing an order. A display monitor is also positioned at the food preparation station for displaying a photo-realistic image of the raw ingredients of the pizza ordered by the customer and a display monitor is positioned at the packaging station for displaying photo-realistic image of the cooked pizza ordered by the customer insuring that the correct pizza is delivered to the correct customer.

### BACKGROUND OF THE INVENTION

1. Field of the Invention

The present invention relates to the operation of a restaurant, and in particular to a video monitor based system for enhancing the order taking, food preparation and food delivery functions of a pizza restaurant toward minimizing waste, minimizing errors and maximizing customer satisfaction.

2. The Prior Art

A customer in a typical restaurant commonly views a menu to determine the various food and drink items available for order. In a sit-down table service style restaurant the menu is most commonly provided in printed form to the customer for viewing. In a modern fast-food restaurant, the menu is typically provides as signage hung on the wall behind the order counter for viewing.

A fast food restaurant offering drive-through service typically displays a menu in the form of signage mounted on a wall or stanchion viewable by the customer from behind the wheel of a car. In each case, the customer verbally interacts with a human employee of the restaurant who takes the order and writes an order ticket or enters the order into a computer driven point-of-sale system. A drive-through customer typically speaks to an order taker via an intercom which sometimes includes a video screen which displays in text the individual items entered by the order taker.

In each of the foregoing examples, the menu is primarily in textual form which requires the customer to read and understand the printed text to first identify what is available for order and second to convey to the order taker what items they wish to order. While menus in family style restaurants often include pictures or images of food and drink items, the offerings pictured are commonly limited to special or featured items. Moreover, the sheer number of different food and drink items offered precludes providing an image or picture of each available item—yet alone each and every variation or combination.

In addition, many restaurants provide customers the ability to custom order their food or drink, as is the case in virtually every pizza restaurant. A pizza restaurant typically offers the customer the option of specifying the type of pizza (thin, thick, pan); the type of crust (white, wheat); and of course the type and quantity of toppings (cheese, pepperoni, double cheese, double pepperoni etc . . . ). Given the number of available choices and options a pizza restaurant could offer thousands of individual different pizzas—all of which cannot possibly be pictured on a menu.

The vast number of options creates the potential for error both in the order taking process as well as in the food preparation and delivery phases. Errors result in food waste, lost time incurred in remaking orders, and also, additional expense associated with giving customers free items to make up for errors and regain good will. In addition, the volume of pizzas a restaurant may prepare for delivery in a given period of time may contribute to mistakes in packing the pizzas for delivery and such that customers are delivered the wrong food items or drink—notwithstanding that the order was correctly received and the correct items prepared by the kitchen.

Accordingly, it is incumbent upon the customer to initially specify the food items they desire order by relying primarily upon a printed textual menu. Moreover, once an order is taken by a waiter, waitress or at the order counter, the order must be transmitted to the kitchen for preparation and delivery to the customer, be it dine-in or carry-out. Again, while computer based order entry and point-of-sale systems have grown common place, they still mainly rely upon printed order tickets or text based video displays viewed by restaurant employees to perform their assigned tasks.

In addition, food quality and appearance are important factors in any restaurant. The order must not only be filled accurately and taste good, but the food must be visually pleasing to the eye, uniform from order-to-order and visit-to-visit, preferably must correspond to the visual image of the food item the customer expects to receive, that is often based upon in-store signage and television advertising.

Customers who do not receive what they order, who receive something they did not expect, regardless of the cause, or who find their dining experience to vary from visit to visit are unlikely to return to the restaurant and worse, are likely to tell others of their displeasure.

Accordingly, it is an object of the present invention to provide the customer the ability to confirm that the order taker has accurately captured and entered their food order providing the customer with a visual image or picture of the exact items it is believed the customer has ordered.

It is another object of the invention to overcome language barriers which may exist between customers and restaurant employees by providing both the customer and the restaurant employees with visual images or pictures of the exact items the customer has ordered.

It is a further object of the present invention to enhance the dining experience of a customer and minimize the opportunity for mistake, whatever the cause, by providing visual images or pictures of the exact items the customer has ordered.

It is a further object of the present invention to provide the kitchen staff responsible for food preparation with a visual display or picture of the food items which has been ordered and which they are to prepare toward insuring accurate fulfillment of the order, proper portion control and uniformity from order to order.

It is still another object of the present invention to provide the kitchen staff responsible for packing the prepared food items with a visual display or picture of the food item which has been ordered and which they are to package toward insuring that the proper food items are associated with the proper order toward accurate delivery to the proper customer.

These and other desirable characteristics of the present invention will become apparent in view of the present specification, including claims, and drawings.

### SUMMARY OF THE INVENTION

The present invention relates to the operation of a restaurant, and in particular to the operation of a pizza restaurant. The present system can be used at the customer counter during the placement of an order, in the kitchen at a “make table” where a customer's pizza is assembled for cooking in the oven, and/or at the packing station where a customer's pizza is removed from the oven and placed in the carton or container for delivery to the customer.

The present system generally comprises one or more display monitors positioned in various places within the pizza restaurant. In the preferred embodiment of the invention, the display monitors are placed at each of the customer order station, at the kitchen “make line” station and at the pizza packing station. The monitors so positioned assist to confirm the correctness of the order to the customer, cook and/or packer and assist restaurant employees in performing their assigned tasks. It is understood that the invention covers the placement of the monitors at any or all of the three positions.

The graphical display system as disclosed has particular use with a point-of-sale system operated in a pizza restaurant. The system comprises an image generator connected to a point-of-sale system which is capable of generating visual images of cooked and uncooked pizzas. One or more customer display monitors connected to the image generator are positioned at one or more customer order stations for displaying an image of a cooked pizza ordered by the customer toward permitting the customer to confirm the correctness of the order. One or more kitchen display monitors connected to the image generator are positioned at a food preparation station for displaying an image of a pizza ordered by the customer in its raw uncooked form toward permitting the accurate preparation of the pizza ordered by the customer. One or more packing station display monitors connected to the image generator are positioned at a packing station for displaying an image of a pizza after cooking toward insuring that the correct pizza is delivered to the correct customer. In the preferred embodiment of the invention, the images generated by the image generator are photo-realistic images which may be either still images generated from a stored database of discrete images or images generated on demand in an animated fashion.

The customer display monitor is further configured to display promotional offers to the customer or provide other information, such as an indication of how many people can be fed by the food item ordered. The present invention may be used to generate visual images of food items other than pizza and has particular utility in connection with food items which may be customized or ordered in varying combinations.

The customer display monitor may be positioned at the customer order station, or may comprise a PDA or wireless telephone capable of receiving and displaying color images. In addition the customer display monitor may be positioned proximate a drive through lane toward presenting a visual image viewable by an individual in a motor vehicle.

A method for confirming the correctness of an order for pizza placed by a customer is also disclosed. The method comprises the steps of accepting a customer order for a pizza with specific ingredients; inputting the customer's order into a computer based point-of-sale order entry system; displaying a photo-realistic image of the pizza ordered by the customer toward permitting the customer to confirm the accuracy of the order as entered into the point-of-sale system; accepting the customer's confirmation of the accuracy of the order as entered; and forwarding the customer's order to the kitchen for preparation and cooking. In addition, the method may further include the step of displaying to kitchen employees a photo-realistic image of a pizza ordered by the customer in its uncooked form toward permitting the kitchen to accurately prepare the pizza as ordered by the customer as well as the step of displaying to kitchen employees a photo-realistic image of a pizza ordered by the customer in cooked form toward permitting the kitchen to accurately match the cooked pizza to the proper customer's order. The method also may be applied to ordering food items other than pizza.

### BRIEF DESCRIPTION OF THE DRAWINGS

FIG. 1 is a schematic representation of the components of the preferred embodiment of the present invention.

FIG. 2 is a flowchart illustrating the method disclosed in the preferred embodiment of the invention.

### DETAILED DESCRIPTION OF THE DRAWINGS

While the present invention is susceptible of embodiment in various forms, there is shown in the drawings and will hereinafter be described several embodiments of the invention, with the understanding that the present disclosure is to be considered as an exemplification of the invention, and is not intended to limit the invention to the specific embodiments illustrated.

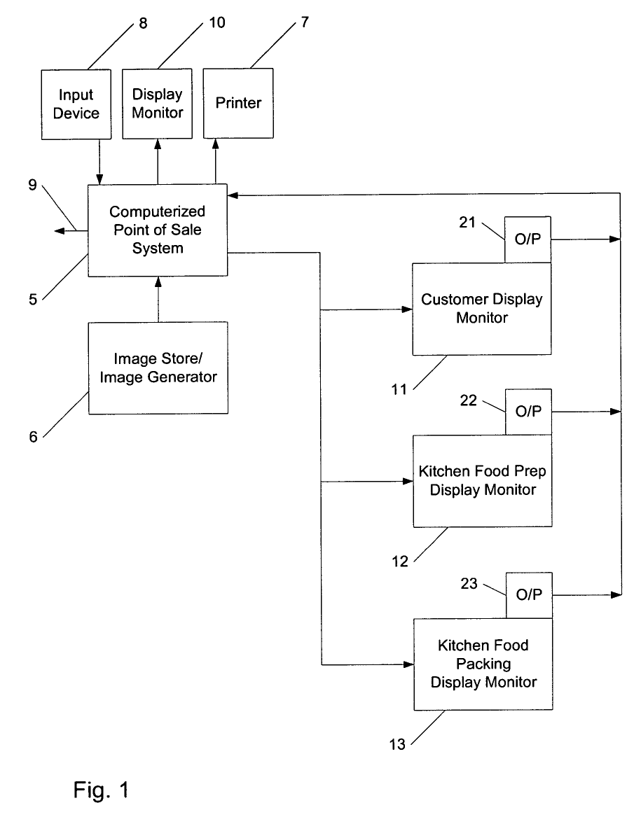

FIG. 1 of the drawings is a schematic representation of the present system wherein remote display monitors 11, 12, and 13 and associated output devices 21, 22 and 23 are illustrated connected to a central point-of-sale system 5 located within or operated by a restaurant. The present invention is disclosed, in part, in the context of a pizza restaurant, with the understanding that the invention is no so limited and may indeed be utilized in virtually any food service operation where a material quantity of different and unique food items are available for order.

Point-of-sale system 5 serves to permit entry of customers' food and drink orders. System 5 is commonly known to those skilled in the art as comprising, at a minimum, a microprocessor based processor connected to a cash drawer or register, data entry terminal 8, display 10 and printer 7, providing entering orders, accepting payments, making change and generating printed receipts for customers. In practice one or more of the various components can be combined into a single device. For example a computerized terminal can include a cash drawer, a display screen 10, a computer keyboard 8, a printer 7 and an integrated microprocessor and software for controlling operation of then system. Point-of-sale system 5 may be located at an order counter staffed by restaurant employees who interact directly with customers placing food orders, or may be configured as a stand-alone terminal used by restaurant waiter and waitress staff.

The point-of-sale system 5 further includes an image storage device and/or image generator which serves to generate images of each of the unique food items which are available for order that are in turn displayed to the customer and/or restaurant employees as further described herein.

In the initial embodiment of the present invention, display monitor 11 is connected to the computerized point-of-sale system 5 operated by the restaurant and is positioned so as to viewable by the customer placing an order for food or drink. The monitor may comprise a convention CRT display or LCD display. Monitor 11 may be integrated into the point-of-sale system 5 or may be external thereto. Alternatively, a single point-of-sale display 10 may also serve the function of monitor 11 where, for example, the point-of-sale monitor 10 may be configured to swivel so as to be made viewable to both the restaurant order taker and the customer. Output device 21 is provided to permit the customer to indicate his or her confirmation of the accuracy of the order as entered.

A typical customer orders a pizza by phone or in person. According to the preferred embodiment of the present invention, a customer who comes into a pizza restaurant steps up to a counter and orders one or more food items by speaking to an order taker. The food order can be for carry-out or for consumption on premises.

To avoid miscommunication between the customer and the order taker, misunderstanding by the customer and to further enhance the sales and restaurant dining experience, monitor 11 is positioned so as to be viewable by the customer during the order placement process. As the order taker enters the customer's order into the point-of-sale system, the computerized point-of-sale system 5 generates a visual image on display 11 which, in turn, presents the customer with a photo-realistic image of the food item(s) the order taker has noted as being ordered. Alternatively as described above, monitor 10 can be used first by the order taker to enter the customer's order and then “swiveled” to be viewed by the customer. If multiple pizzas are ordered, each can be displayed sequentially to the customer. Output control 21 can be used by the customer to scroll the display to view each individual food or drink item ordered.

As an example, a customer may order a large pizza with cheese and pepperoni toppings. In response to the order taker's entries, the system 5 will cause an image of a cooked cheese and pepperoni pizza to appear on display 11. A separate image of the thickness of the pizza may also be displayed to confirm the type of pizza ordered. It is preferred that the displayed image be in color so as to accurately convey as much information as possible. It is further contemplated that the image presented to the user as a still image, that also may be displayed rotating or tilting so as to give perspective to the image.

As an alternative, the image displayed to the customer need not be a static still image depicting only the complete finished pizza, but may also depict the pizza being assembled for cooking. In the later case the pizza is “built-up” step-by-step or ingredient-by-ingredient, as they are specified by the customer and entered into the system by the order taker.

The display monitor is preferably 17 inches or larger, though a smaller monitor may suffice. If the monitor is at least the size of the largest pizza sold by the restaurant a life-size image can be displayed further confirming the order to the customer and enhancing the sales experience. The pizza displayed can be shown whole or cut into pieces conveying the total number of slices or pieces the particular size pizza will provide. The display can further include captions which convey information to the customer such as how many people the pizza as ordered will typically feed.

The present system can further be configured to display pricing or promotions to the customer alerting the customer to special offers or to suggest the purchase of related or compatible food items. For example, the system may generate a still or scrolling message suggesting that the customer also order a particular item, or may provide an “electronic” coupon entitling the customer to a discount on the purchase of another item. The system may include a database of offers and promotions which are recalled and displayed based upon a customer's order, or other parameters, such as time of day, day of week, or even the customer's identity.

Additionally, if a customer initially specifies one size pizza and during the order process changes his or her mind and specifies a larger or smaller pizza, the display monitor 11 will re-generate and re-display the images to reflect to the updated order.

Pizza ingredients or toppings are shown appearing on the whole or either half of the pizza, depending upon the customer's order. The customer can readily see the finished pizza and can verify that it meets with their expectations and/or that it conforms to what was ordered. Order taker mistakes or customer mistakes can be caught and corrected before the order is passed on to the kitchen for preparation.

The generation of the displayed images of a finished pizza can be accomplished through a variety of techniques and technologies. While photo-realistic images are preferably displayed, lower quality images may be stored and/or generated. In a most direct fashion, a discrete photo-realistic image of a finished pizza is displayed. The system is provided with an electronic or optical storage medium and/or image generator 6 populated with discrete photo-realistic images corresponding to each of the multitude of possible order combinations and/or the building blocks to generate a complete image on demand. Alternatively, a display layer technique can be employed where the photo-realistic image is built up layer-by-layer. In such a system, transparent layers may be used to cause image layer to appear. Semi-transparent layers can also be used to add effect to the displayed image. In either case, the image of the finished pizza appears viewable by the customer. External connection 9 permits updating of store images or menu changes.

The technique of displaying the image of a finished pizza can also be extended by the present system to customers who phone their order into a pizza restaurant. For example, the present system can generate graphical images for transmission to a user's cell phone capable of displaying color images, or to a user's compatible pocket PDA, if so enabled.

Alternatively, a remote customer operated computer may be connected to the pizza restaurant toward having the same desired result. Of course, the computer may be a work station, laptop or a kiosk operated by the restaurant.

The foregoing use of a display at a customer order station provides great benefit to both the customer and the restaurant by providing a mechanism for catching mistakes and minimizing waste. Customer satisfaction is enhanced and a restaurant is provided with a means to up-sell or otherwise promote other food items or specials.

An alternative embodiment of the present system provides for use of display monitors in other areas of a pizza restaurant. For example, one or more monitors 12 can be positioned proximate the make-line or food preparation area where the raw ingredients of a pizza are assembled on a pizza crust by food preparation employees for cooking in the oven. Monitors 12 can be sized to provide a life-size image of the pizza which corresponds exactly to the size pizza ordered by the customer. This make-line monitor 12 is likewise connected to the computerized point-of-sale system. When prompted by the system to make another pizza, the cook is provided with a photo-realistic image of the pizza to be cooked. Alternatively, the cook may command the system to display the next order by using an output device 22 associated with monitor 12. Unlike the pizza displayed to the customer when ordering, the pizza displayed to the cook shows the ingredients in their raw condition. Sequence, placement and quantity of each ingredient can be conveyed to the cook by animation, layered images or sequential depiction of images or textual overlays. The particular language skill or reading level of kitchen personnel is no longer a barrier to efficient and accurate food preparation.

As with the customer display, the pizza can be built up ingredient-by-ingredient. The cook can be walked through the process of assembling the pizza ingredient-by-ingredient. The cook will see on the display the order in which raw ingredients are to be applied to the pizza. The size of the pizza, the quantity of ingredients and their placement on the raw crust is also shown to the cook. The system can also command that a cook weigh the pizza before being placed in the oven to assure that proper quantity standards are met and quality is maintained. In this manner, errors can be prevented and ultimate customer satisfaction is maintained and enhanced.

A still further embodiment of the present embodiment utilizes a display monitor 13 positioned at the packing station proximate the area in which pizzas are removed from the oven and placed in cartons or containers for delivery to the customer.

In a typical computerized point-of-sale system, an order ticket is typically printed by the system and given to the kitchen to instruct the cook as to what food items have been ordered. Such systems may also print bar coded labels which are applied to the cardboard carton frequently used to hold the finished pizza for delivery to the customer. The label may be applied to the carton immediately upon being printed or may be left loose at the packing station to be used when a finished pizza is removed from the oven and packaged.

The bar code label is typically scanned by the packer using a bar code reader connected to the point-of-sale system 5, to signal the point-of-sale system that the pizza has left the oven and is on its way to the customer. When the bar code label is scanned, the system 5 causes an image of the finished pizza to appear on the display monitor 13. The packer can thus visually recognize the pizza that is to be packed and visually verify the packer is indeed putting the correct pizza into the correct box or container. The display 13 can further contain an overlay displaying an order number or customer name to further insure that the right customer is getting the right pizza. Using output control 23 the packer may control monitor 13.

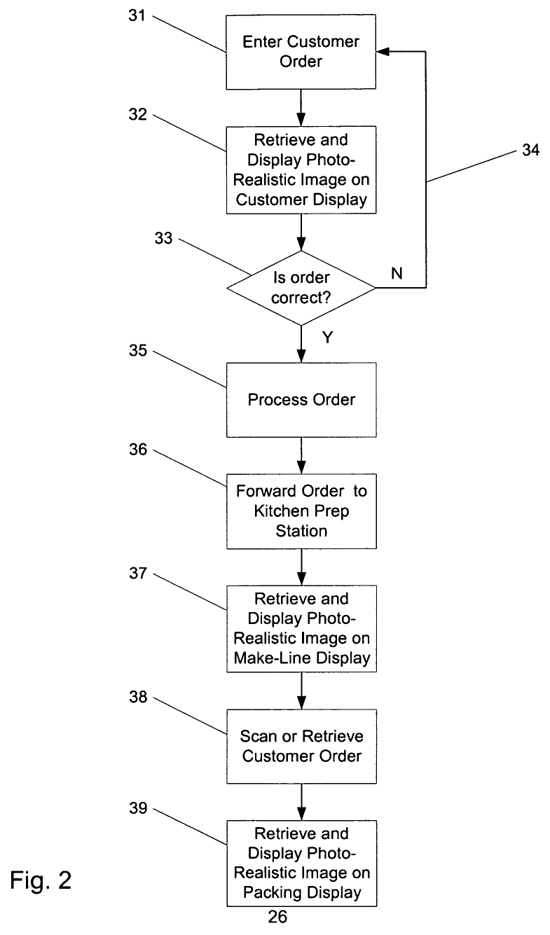

The process by which the system operates is illustrated in FIG. 2. The customer provides his/her order to the restaurant employee who, in turn, enters the order into the point-of-sale system, step 31. The system responds by retrieving a photo-realistic image of the pizza or other food item ordered and displaying the image to the customer, step 32. The customer is then asked to confirm that the order is correct, step 33. If not, the process begins again and the order can be corrected, step 34. If the order is deemed correct the order is released to the kitchen for processing, step 35. The order is forwarded to the kitchen where it may be printed out or displayed on a monitor, step 36. The visual image of the pizza to be prepared is then retrieved and displayed on the monitor located in the kitchen preparation area, or make-line, step 37. After the pizza has been cooked it is ready for packing for delivery to the customer. The restaurant employee may scan the order bar code or otherwise retrieve an order, step 38. The visual image of the pizza associated with that order is then retrieved and displayed on the monitor located in the kitchen packing area, step 38.

The foregoing system while described in the context of a pizza restaurant can further be applied to restaurants serving other food items for in-store dining, carry out, or delivery. In addition, the customer monitor 11 may also be positioned in a drive-through lane of a fast-food restaurant, or at a stand-alone kiosk should one be provided for a customer to order and pay for food and drink without interacting with any restaurant employee.

The foregoing description and drawings merely explain and illustrate the invention and the invention is not limited thereto, as those skilled in the art who have the disclosure before them will be able to make modifications and variations therein without departing from the scope of the invention.

What is claimed is:

1. A graphical display system for use with a point-of-sale system operated in a pizza restaurant, the display system comprising:
an image generator connected to a point-of-sale system, the image generator capable of generating visual images of cooked and uncooked pizzas;
one or more customer display monitors connected to the image generator and positioned at one or more customer order stations for displaying an image of a cooked pizza ordered by the customer toward permitting the customer to confirm the correctness of the order;
one or more kitchen display monitors connected to the image generator and positioned at a food preparation station for displaying an image of a pizza ordered by the customer in its raw uncooked form toward permitting the accurate preparation of the pizza ordered by the customer; and
one or more packing station display monitors connected to the image generator and positioned at a packing station for displaying an image of a pizza after cooking toward insuring that the correct pizza is delivered to the correct customer.

2. The graphical display system according to claim 1 wherein the images generated by the image generator are photo-realistic images.

3. The graphical display system according to claim 1 wherein the images generated by the image generator are still images.

4. The graphical display system according to claim 1 wherein the images generated by the image generator are generated from a stored database of discrete images.

5. The graphical display system according to claim 1 wherein the customer display monitor displays promotional offers to the customer.

6. The graphical display system according to claim 1 wherein the customer display monitor presents to the customer an indication of how many people can be fed by the food item ordered.

7. A graphical display system for use in a restaurant, the display system comprising:
an image generator connected to a point-of-sale system, the image generator capable of generating visual images of cooked and uncooked food items;
a customer display monitor disposed to display to a customer a photo-realistic image of the cooked food items ordered by the customer;
a kitchen display monitor positioned at the food preparation station for displaying a photo-realistic image of food items ordered by the customer in its raw uncooked form; and
a packing display monitor positioned at the packing station for displaying a photo-realistic image of the cook food ordered by the customer toward insuring that the correct food is delivered to the correct customer.

8. A graphical display system for use in a restaurant according to claim 7 wherein the customer display monitor is positioned at the customer order station.

9. A graphical display system for use in a restaurant according to claim 7 wherein the customer display monitor is a PDA is capable of displaying color images.

10. A graphical display system for use in a restaurant according to claim 7 wherein the customer display monitor is a cell phone capable of displaying a color image.

11. A graphical display system for use in a restaurant according to claim 7 wherein the customer display monitor is positioned proximate a drive through lane toward presenting a visual image viewable by an individual in a motor vehicle..

12. A method for confirming the correctness of an order for pizza placed by a customer, the method comprising the steps of:
accepting a customer order for a pizza with specific ingredients;
inputting the customer's order into a computer based point-of-sale order entry system;
displaying a photo-realistic image of the pizza ordered by the customer toward permitting the customer to confirm the accuracy of the order as entered into the point-of-sale system;
accepting the customer's confirmation of the accuracy of the order as entered; and
forwarding the customer's order to the kitchen for preparation and cooking.

13. The method according to claim 12 further including the step of:
displaying to kitchen employees a photo-realistic image of a pizza ordered by the customer in its uncooked form toward permitting the kitchen to accurately prepare the pizza as ordered by the customer.

14. The method according to claim 12 further including the step of:
displaying to kitchen employees a photo-realistic image of a pizza ordered by the customer in cooked form toward permitting the kitchen to accurately match the cooked pizza to the proper customer's order.

15. A graphical display system for use with a point-of-sale system operated in a pizza restaurant, the display system comprising:
an image generator connected to a point-of-sale system, the image generator capable of generating visual images of cooked pizzas; and
one or more display monitors positioned at customer order stations for displaying to the customer a photo-realistic image of the cooked pizza ordered by the customer toward permitting the customer to confirm the correctness of the order as entered into the point-of-sale system.

16. A graphical display system for use in a pizza restaurant, the display system comprising:
an image generator connected to a point-of-sale system, the image generator capable of generating visual images of uncooked pizzas; and
one or more display monitors positioned at a food preparation station for displaying to the kitchen employees a photo-realistic image of a pizza ordered by the customer in uncooked form toward facilitating the accurate and uniform preparation of the pizza.

17. A graphical display system for use in a pizza restaurant comprising:
an image generator connected to a point-of-sale system, the image generator capable of generating visual images of cooked pizzas; and
one or more display monitors positioned at a packing station for displaying to the kitchen employees a photo-realistic image of the cooked pizza ordered by the customer toward matching the cooked pizza with the correct customer's order, to in turn, insure that the correct pizza is delivered to the correct customer.

18. A graphical display system for use in a restaurant according to claim 15 wherein the display monitor is positioned at the customer order station.

19. A graphical display system for use in a restaurant according to claim 15 wherein the display monitor is a PDA is capable of displaying color images.

20. A graphical display system for use in a restaurant according to claim 15 wherein the display monitor is a cell phone capable of displaying a color image.
